(19) United States
(12) Patent Application Publication
(10) Pub. No.: US 2026/0244710 A1
(43) Pub. Date: Aug. 20, 2026

(54) SYNTHETIC DATA GENERATATION SYSTEMS AND APPLICATIONS

(71) Applicant: Incucomm, Inc., Addison, TX (US)

(72) Inventors: Raul Rios, Dallas, TX (US); Steven D. Roemerman, Highland Village, TX (US); Eric Haney, Dallas, TX (US)

(73) Assignee: Incucomm, Inc., Addison, TX (US)

(21) Appl. No.: 19/000,364

(22) Filed: Dec. 23, 2024

Related U.S. Application Data
(60) Provisional application No. 63/613,429, filed on Dec. 21, 2023.

(51) Int. Cl. G06F 18/214; G06F 16/215; G06N 3/0495

(52) U.S. Cl. CPC G06F 18/2148; G06F 16/215; G06N 3/0495

(57) ABSTRACT

A synthetic data generation (“SDG”) system configured to receive a source dataset, apply a data bound to the source dataset to create a bounded source dataset, transform the bounded source dataset to create a transformed dataset, compute an empirical cumulative distribution function (“eCDF”) of the transformed dataset to create eCDF probability values, normalize the eCDF probability values to create scaled eCDF values, perform regression on the scaled eCDF values to create metalog distribution models for the scaled eCDF values, and determine one of the metalog distribution models that meets a measure of merit to create a generative model. The SDG system is configured to receive random input data, calculate an inverse CDF based on the generative model, apply the random input data to the inverse CDF to create metalog samples of the random input data, and apply an inverse transformation to the metalog samples to create a synthetic dataset.

### CROSS-REFERENCE TO RELATED APPLICATION

This application claims the benefit of U.S. Provisional Patent Application No. 63/613,429, entitled “Rich Synthetic Data Generator Systems and Applications,” filed Dec. 21, 2023, which is incorporated herein by reference.

This application is related to U.S. patent application Ser. No. 18/146,049 entitled “Adaptive Distributed Analytics System,” filed Dec. 23, 2022 (now U.S. Pat. No. 12,013,680 issued Jun. 18, 2024); U.S. patent application Ser. No. 18/050,661 entitled “System and Method for Adaptive Optimization,” filed Oct. 28, 2022; U.S. patent application Ser. No. 16/674,942 entitled “System and Method for Constructing a Mathematical Model of a System in an Artificial Intelligence Environment,” filed Nov. 5, 2019; and U.S. patent application Ser. No. 18/773,333 entitled “Generative Artificial Intelligence System and Method of Operating the Same,” filed Jul. 15, 2024, which are incorporated herein by reference.

### RELATED REFERENCES

Each of the cited references are incorporated herein by reference.

### Nonpatent Literature Documents

Thomas W. Keelin (2016) The Metalog Distributions. Decision Analysis 13 (4): 243-277. https://doi.org/10.1287/deca.2016.0338;
Thomas W. Keelin (2023) The Multivariate Metalog Distributions with Application to Strategic Decision-Making in Golf. http://metalogdistributions.com/publications.html; and
Raul Rios (2023) Multivariate Metalog Distribution Model and Compression. https://www.lone-star.com/technical-publications-rd/.

### TECHNICAL FIELD

The present disclosure is directed, in general, to information systems and, more specifically, to synthetic data generation systems, methods and applications to control complex systems.

### BACKGROUND

To anonymize data is to remove the link between an individual and their data to the degree that it would be virtually impossible to reestablish the link just from the data. In applications for protecting sensitive data (e.g., personally identifying information), a common reversible anonymization strategy is deidentification (sometimes referred to as depersonalization). However, studies have shown that deidentification is often insufficient to prevent re-identification of individuals from their data; in some cases, zip code, gender, and age are sufficient characteristics to uniquely identify individuals. Synthetic data generation (“SDG”) offers a truly anonymous process by which artificial data is created algorithmically to mimic a desired real dataset. While there are SDG systems available, they tend to be complex requiring large amounts of data. What is needed is a robust approach to SDG that is less complex and applicable to source datasets of any size.

### SUMMARY

Deficiencies of the prior art are generally solved or avoided, and technical advantages are generally achieved, by advantageous embodiments of the present disclosure of a synthetic data generation (“SDG”) system, and method of operating the same. In one embodiment, the SDG system includes a processor and memory configured to receive a source dataset, apply a data bound to the source dataset to create a bounded source dataset, transform the bounded source dataset to create a transformed dataset, compute an empirical cumulative distribution function (“eCDF”) of the transformed dataset to create eCDF probability values, normalize the eCDF probability values to create scaled eCDF values, perform regression on the scaled eCDF values to create metalog distribution models of differing order for the scaled eCDF values, and determine one of the metalog distribution models of differing order that meets a measure of merit to create a generative model. The SDG system is further configured to receive random input data, calculate an inverse cumulative distribution function (“CDF”) based on the generative model, apply the random input data to the inverse CDF to create metalog samples of the random input data, and apply an inverse transformation to the metalog samples to create a synthetic dataset of the source dataset.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, reference is now made to the following detailed description taken in conjunction with the accompanying drawings, in which:

FIG. 1 illustrates a graphical representation of an example probability distribution model for synthetic data generation;

FIG. 2 illustrates a block diagram of an example process for generating synthetic data;

FIG. 3 illustrates a block diagram of an example of data fitting process for a model creation process of a synthetic data generation system;

FIG. 4 illustrates a block diagram of an example generative adversarial network training method for a synthetic data generation system;

FIG. 5 illustrates a block diagram of an example method for a data fitting process for a model creation process of a synthetic data generation system;

FIG. 6 illustrates a block diagram of an example method for a data fitting process for a model creation process of a synthetic data generation system;

FIG. 7 illustrates a block diagram of an example method for generating a synthetic dataset using a synthetic data generation of a synthetic data generation system;

FIG. 8 illustrates a block diagram of an example application for the data fitting process of FIG. 6;

FIG. 9 illustrates a block diagram of an example application for the data fitting process of FIG. 6; and

FIG. 10 illustrates a block diagram of an embodiment of an apparatus for operating systems and processes described herein.

Corresponding numerals and symbols in the different figures generally refer to corresponding parts unless otherwise indicated and, in the interest of brevity, may not be described after the first instance.

### DETAILED DESCRIPTION

As mentioned above, synthetic data generation (“SDG”) offers a truly anonymous process by which artificial data is created algorithmically to mimic a desired real dataset. SDG irreversibly anonymizes the output data since synthetic dataset has no direct link to individual samples in the source, private dataset. SDG captures certain desired attributes of the real data including statistical measures and underlying patterns of the source dataset, making it a useful technique. Aside from data anonymization, SDG can simulate unavailable datasets, or augment datasets that contain insufficient amounts of data. Complex systems where SDG can be applied include banking and financial services, the healthcare systems, security and defense, and any field that makes use of training artificial intelligence (“AI”).

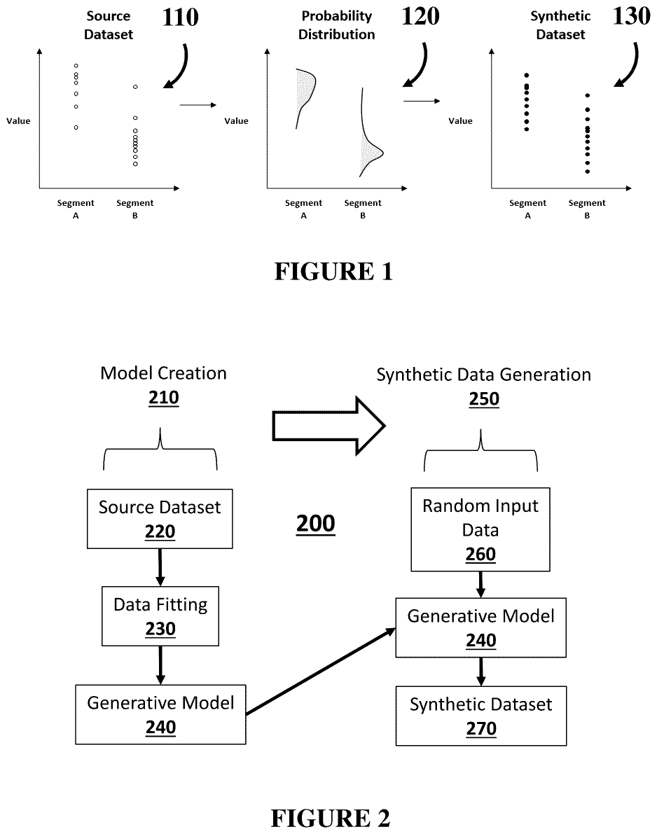

FIG. 1 illustrates a graphical representation of an example probability distribution model for synthetic data generation. The technique includes fitting parameters of a classic probability distribution to a representative source dataset 110 and then drawing random samples from a probability distribution 120 to derive a synthetic dataset 130.

When fitting a probability distribution 120 to a source dataset 110, a practitioner considers a large number of potential distributions and examine many potential parameters before finding a good fit. This is typically a manual and time-intensive task. The quality of the SDG dataset is directly tied to the careful, intelligent selection of an appropriate probability distribution 120, and because this process is often non-trivial, there are instances where a suboptimal model is chosen. Using inaccurate probability distribution models can lead to erroneous conclusions about the source dataset 110, and in critical decision areas (e.g., healthcare) this can have an adverse effect on people's lives. Great benefit would be achieved from a simplified, streamlined alternative.

With the advent of AI and deep learning, generative adversarial network (“GAN”) AI models offer another avenue for SDG. A GAN is a deep learning framework that iteratively trains two competing neural networks including a generator and a discriminator. The desired end result of this training process is a generator that produces synthetic data (or dataset) that is indistinguishable from the real data (or dataset). However, a GAN cannot be applied to just any dataset. Like traditional AI models, a GAN employs a large amount of source data to train on to produce acceptable results. Because of this, GANs and other deep learning techniques fail in some of the most critical, data-starved problems; for instance, modelling rare, complex illnesses in healthcare or modelling new, rarely observed technology for national security.

The synthetic data generation (“SDG”) system described herein is less complex and applicable to source datasets of any size. This can be achieved by employing a modelling technique capable of generalizing to any probability distribution shape without specialized knowledge of different probability distribution models, and that can be used with a trivially small amount of data samples. Disclosed herein is such a modelling technique that uses a general probability distribution model that is flexible enough to fit multivariate datasets with as few as two samples and uses estimates of the bounds of the underlying data.

The benefits of the technique described hereinafter include lower compute requirements, faster model generation, compatibility with limited-data applications, and a compact, low-footprint model representation that can be applied to complex systems as compared to traditional AI such as a GAN. These benefits enable application of this teaching in complex systems heretofore unreachable by traditional AI methods such as: SDG on edge processors such as those involved in an “Adaptive Distributed Analytics System” (U.S. Pat. No. 12,013,680 introduced above); SDG model generation and compressed data representation for use in characterization of remote sensors; analysis of low-observability source datasets such as may arise in healthcare studies of rare diseases; intelligence gathering of rare assets; or supply chain complications resulting from rare events. In addition, the disclosed methodology increases accessibility to SDG for non-expert practitioners by removing the need to consider a large number of potential probability distribution models explicitly; the SDG system and method described herein does so automatically with minimal user input.

FIG. 2 illustrates a block diagram of an example process for generating synthetic data. There are two phases to the process of generating synthetic data, namely, model creation 210 and synthetic data generation 250. The model creation 210 creates a generative model 240 from a source dataset 220. The synthetic data generation 250 uses the generative model 240 to generate a new synthetic dataset 270 using random input data 260. Where approaches primarily differ is in a data fitting process 230 from the model creation 210. The model creation (can also be referred to as a “module creation process”) 210 and synthetic data generation (can also be referred to as a “synthetic data generator or synthetic data generation process”) 250 form the synthetic data generation system 200 described herein.

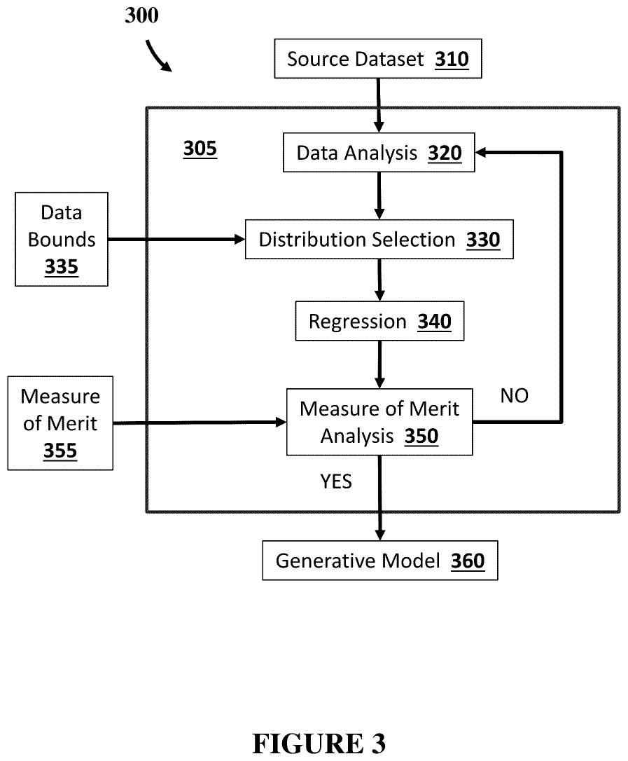

FIG. 3 illustrates a block diagram of an example of data fitting process 305 for a model creation process 300 of a synthetic data generation system. If a classical probability distribution method is chosen for the generative model 360, the data fitting process 305 for a one-dimensional (“1D”) source dataset 310 is as follows. First, the data fitting process 305 analyzes the source dataset 310 using tools such as generating statistical measures, creating histograms, etc. (referred to as data analysis 320).

Next, the data fitting process 305 uses the analysis to select a reasonable class of probability distributions such as Gaussian, logistic, Poisson, etc. (referred to as distribution selection 330). The data fitting process 305 then performs regression 340 to compute the specific model parameters using the source dataset 310. The data fitting process 305 then assesses the goodness of the data fit by computing and testing a measure of merit (referred to as measure of merit analysis 350) in an iterative approach. The dating fitting process 305 returns to the data analysis 320 if the measure of merit analysis 350 is not satisfied, otherwise provides a generative model 360. Tangential to these steps, hyperparameters are selected such as realistic data bounds 335 to provide lower and upper bounds for the underlying data, and selection of an appropriate measure of merit 355. This creates the generative model 360, in this case, for a 1D source dataset 310.

For the data fitting process 305 illustrated in FIG. 3, the data analysis 320 is done manually by a practitioner and requires a thorough understanding of statistics. Similarly, the selection of a specific probability distribution (the distribution selection 330) cannot be done without understanding the merits, properties, and use cases of a multitude of probability distributions. In some cases, it may be necessary to iterate and fit several probability distribution models to be certain that a suitable model choice has been made (e.g., multimodal probability distributions). These limitations are compounded when extending this data fitting process 305 to multidimensional source datasets since the above steps must be repeated for each dimension of the data to create multiple 1D generative models.

The data analysis 320 and the distribution selection 330 of the data fitting process 305 are important and time-intensive, and additionally require specialized knowledge. Iterating of through these steps when an initial generative model fit is deemed inadequate only compounds the time and resources required to create the generative model 360. Inadequacy in this context means that a generative model 360 is a poor fit for the source dataset 310 (in this case a 1D source dataset) as indicated by a chosen measure of merit 355.

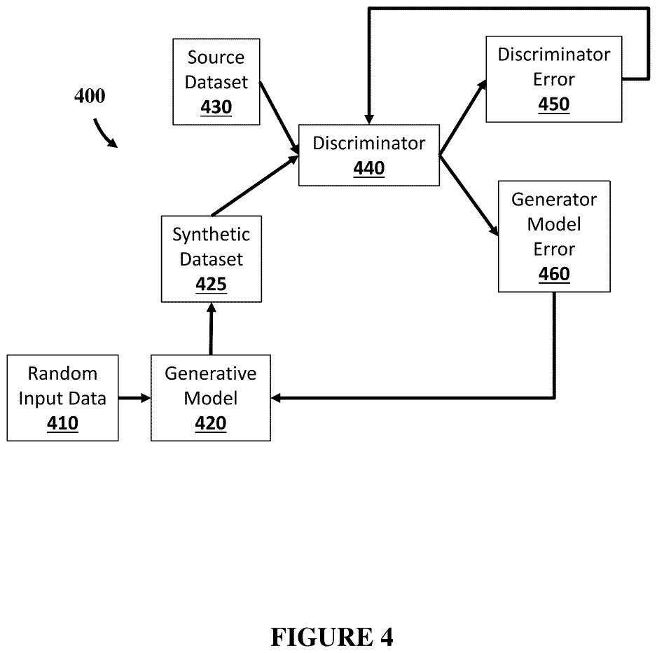

FIG. 4 illustrates a block diagram of an example generative adversarial network (“GAN”) training method 400 for a synthetic data generation system. The GAN training method 400 selects a network architecture for a generative model 420 and discriminator neural networks (referred to as a “discriminator” 440). The networks are trained by iteratively generating a synthetic dataset 425 by feeding random input data 410 to the generator model 420, running the source dataset 430 and the synthetic dataset 425 from the generator model 420 through the discriminator 440, and recording errors (e.g., discriminator error loss 450 and generator error loss 460). The parameters of the discriminator 440 are updated using the discriminator error loss 450, and the parameters of the generator model 420 are updated using the generator error loss 460.

The discriminator 440 is iteratively trained to maximize its ability to correctly distinguish between source dataset 430 and synthetic dataset 425. The generator model 420 is iteratively trained to fool the discriminator 410 into thinking synthetic dataset 425 are actually “real.” Training is completed when user-specified convergence parameters are met, and ideally results in a generator neural network that can reliably create the synthetic dataset 425 similar to the source dataset 430.

GANs are a development of mainstream AI and as such embody many of the same documented issues that plague deep neural networks. In addition to training pitfalls (overfitting data, vanishing gradients, training instability, training collapse, etc.), a salient drawback of GANs for SDG and anonymization applications is the need for a large dataset for training.

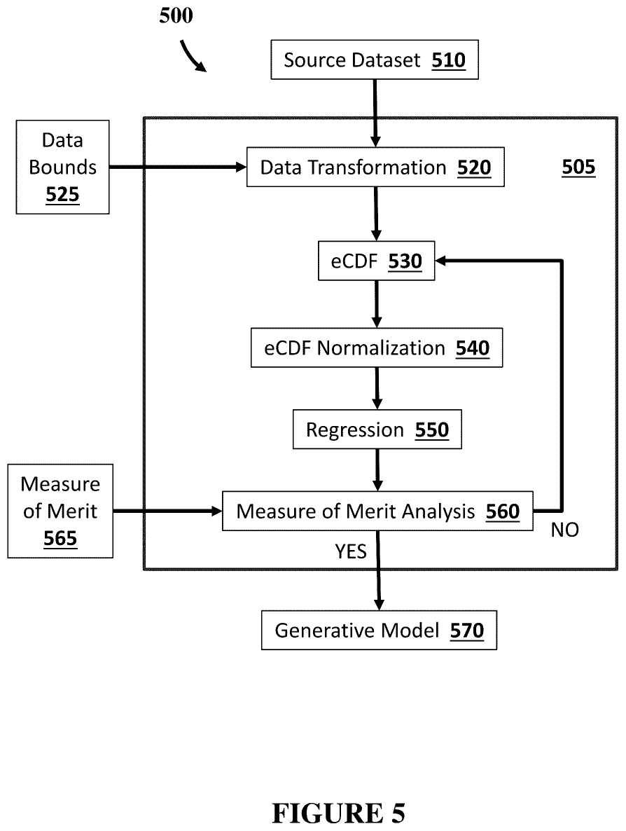

FIG. 5 illustrates a block diagram of an example method for a data fitting process 505 for a model creation process 500 of a synthetic data generation system. The data fitting process 505 simplifies the data fitting process 305 of FIG. 3 for the user via automation. An initial step of the data fitting process 505 is the a priori selection of a generalizable probability distribution that can be shaped into any classical probability distribution, namely, it has been recognized that a metalog distribution model as described by Thomas W. Keelin can be used to advantage.

The metalog distribution model is generally a flexible continuous probability distribution designed for ease of use in practice. Together with its transforms, the metalog family of continuous distributions is unique because it embodies the following properties: virtually unlimited shape flexibility; a choice among unbounded, semi-bounded, and bounded distributions; ease of fitting to data with linear least squares; simple, closed-form quantile function (inverse empirical cumulative distribution function (“eCDF”)) equations that facilitate simulation; a simple, closed-form probability distribution function (“PDF”); and Bayesian updating in closed form in light of new data. Moreover, like a Taylor series, metalog distribution models may have any number of terms, depending on the degree of shape flexibility desired and other application needs.

Applications where metalog distribution models can be useful typically involve fitting empirical data, simulated data, or expert-elicited quantiles to smooth, continuous probability distributions. Fields of application are wide-ranging, and include economics, science, engineering, and numerous other fields. (See, e.g., https://en.wikipedia.org/wiki/Metalog_distribution, which is incorporated herein by reference.)

In selecting the metalog as the singular probability distribution for fitting, the need to consider many different types of probability distributions (manual distribution selection 330 of FIG. 3) is eliminated. Instead, a determination is made on the data bounds 525 for lower and upper bounds, if any, that exist for the source dataset 510. This drives the choice of data transformation 520 of the source dataset 510 (in this case a 1D source dataset) for creating a semi-bounded or bounded metalog distribution model (a bounded source dataset). Unbounded metalog distribution models require no data transformation. This decision step can also be automated by making it a parameter over which to optimize. The data fitting process 505 then takes in the potentially transformed dataset and computes the empirical cumulative distribution function (referred to as eCDF 530) for the source dataset 510. After this, the eCDF probability values are normalized (referred to as eCDF normalization 540) by scaling and shifting the values in such a way to always elicit certain desirable properties to create scaled eCDF values. These properties are that the maximum scaled eCDF value should approach unity as the number of data samples increases, and the minimum scaled eCDF value should be greater than zero to prevent an artificial lower bound.

One option for such a normalization is

$${y}^{′} = \frac{k - 1}{k} y + \frac{1}{2 k}$$

where y is the raw eCDF value, k is the number of eCDF values, and y′ is the normalized output eCDF values. This normalization produces a more accurate regression 550 for the metalog distribution model. In this regression 550, a hyperparameter of the metalog distribution model, namely the “order,” dictates how many metalog distribution terms to use to fit the data's eCDF values. The data fitting process 505 automatically computes several metalog distribution models of differing order (using regression 550 until it finds one that meets the chosen measure of merit (referred to as measure of merit analysis 560)) in an iterative process or approach. The dating fitting process 505 returns to the eCDF 530 if the measure of merit analysis 560 is not satisfied, otherwise provides a generative model 570. Tangential to these steps, hyperparameters are selected such as selection of an appropriate measure of merit 565. This can be done exhaustively over a user-defined list of allowable metalog distribution orders; alternatively an optimizer such as one described in “System and Method for Adaptive Optimization” (U.S. patent application Ser. No. 18/050,661 introduced above) can be employed. Common measures of merit analysis 565 includes goodness-of-fit tests such as the Kolmogorov-Smirnoff (K-S) distance. The generative model 570 for the source dataset 510 takes into account 1D metalog distribution models, their respective data transforms (or bounds), and the correlations between dimensions. Additionally, the generative model 570 of the source dataset 510 provides a significantly compressed version of the source dataset 510.

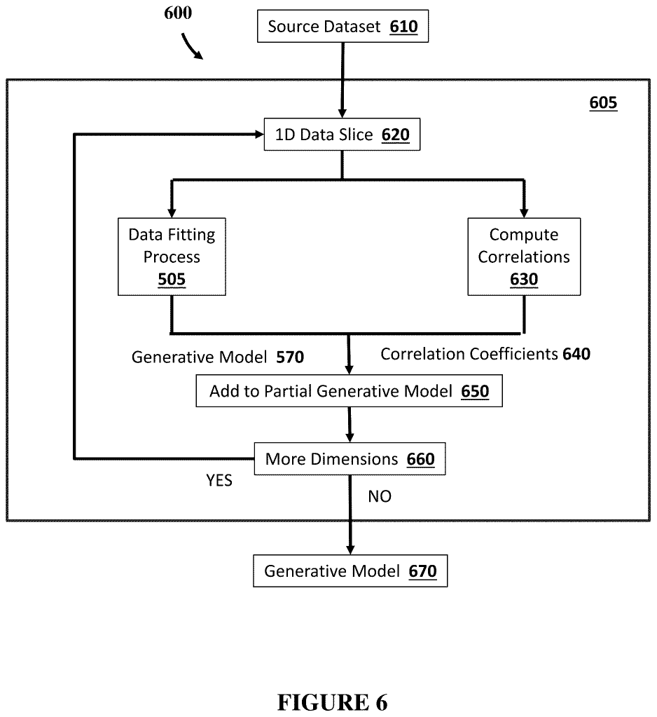

FIG. 6 illustrates a block diagram of an example method for a data fitting process 605 (in this case a multidimensional data fitting process) for a model creation process 600 of a synthetic data generation system. With continuing reference to FIG. 5, for a source dataset 610 with multiple dimensions, each dimension is isolated as a 1D data slice 620 (first one dimensional data slice 620-1 . . . D dimensional data slice 620-D) and the 1D data fitting process 505 are repeated to create 1D generative models 570 (first generative model 570-1 . . . D dimensional generative model 570-D) for data of each dimension, as illustrated in FIG. 6. The correlation coefficients 640 between each pair of dimensions are calculated by compute correlations 630 to preserve the relationships across dimensions (correlated first and second generative models 570-1, 570-D). These steps/modules 505, 620, 630 are incrementally added to a partial generative model 650, which when all dimensions of the source dataset 610 have been processed (via more dimensions 660 iterative process), the full generative model 670 is created. In other words, if more dimensions 660 are present, the data fitting process 605 returns to the 1D data slice 620, otherwise provides a generative model 670. In contrast to the ID data fitting process 505 of FIG. 5, the methodology disclosed herein enables complete automation for the multidimensional data fitting process 605 when the one-dimensional method 505 is employed; the hyperparameter choices are all that is needed to be specified. The generative model 670 created using the multi-dimensional data fitting process 605 becomes part of the synthetic data generation (“SDG”) system useful in many applications, such as those described hereinafter.

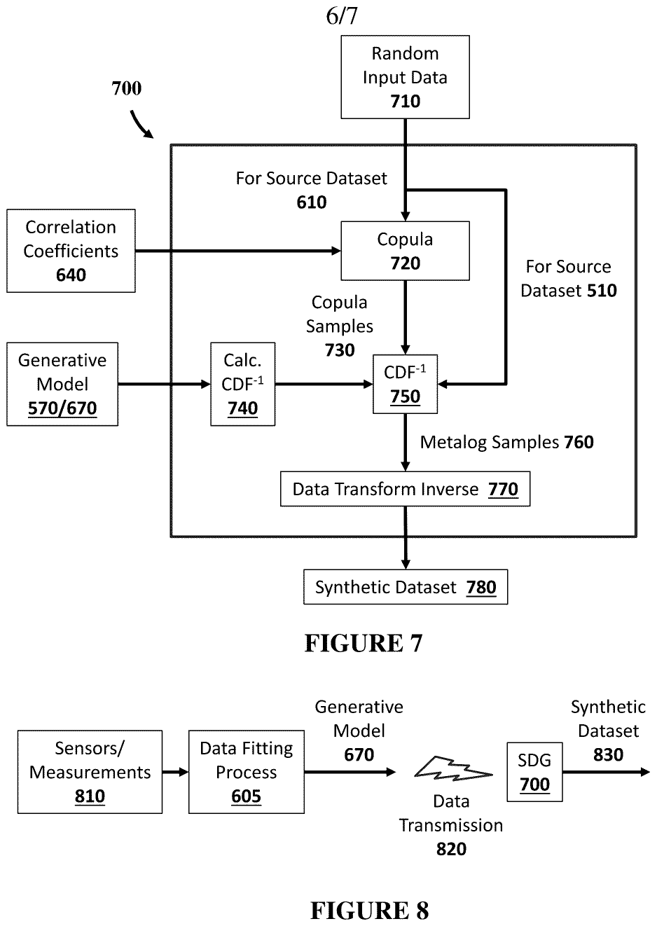

One additional benefit of using the SDG system is that the data fitting process 605 creates a higher compact model representation. It is not unusual for GAN networks to consist of many millions of parameters. In contrast, for a source dataset 610 of D dimensions and n samples, if the 1D metalog distributions of the SDG system are of average order M, then the total number of model parameters is D(D+1)/2+DM. The data fitting process 605 achieves a model representation of a smaller size than the source dataset 610 so long as n>(D+1)/2+DM. Furthermore, the data fitting process 605 achieves a data storage reduction ratio, r, (relative to the source dataset 610) that scales as r=(n−c)/n where c=(D+1)/2+M. Larger r is better. Using the foregoing disclosed method of generating the generative model 670, the SDG system can then be utilized to generate a synthetic dataset using a method similar to doing so using a multidimensional gaussian distribution model, as illustrated in FIG. 7. Additionally, the generative model 670 of the source dataset 610 provides a significantly compressed version of the source dataset 510.

FIG. 7 illustrates a block diagram of an example method for generating a synthetic dataset 780 using a synthetic data generator (e.g., a multidimensional gaussian distribution model generator) 700 of a synthetic data generation system. For the 1D source datasets 510 (see FIG. 5), the 1D generative model 570 is used to calculate 740 an inverse CDF 750, from which representative metalog samples 760 are generated using random input data 710. If the metalog distribution model is semi-bounded or bounded, the data transform inverse 770 of the data transformation 520 (previously used to create the 1D generative model 570 of FIG. 5) is applied to the metalog samples 730 to generate the full synthetic dataset 780. For multidimension source dataset 610 (see FIG. 6), the correlation coefficients 640 are used to create a multivariate copula 720 (e.g., Gaussian), from which copula samples 730 are generated using random input data 710. The multidimensional generative model 670 is used to calculate 740 an inverse CDF 750, from which representative metalog samples 760 are generated via the previously generated copula samples 730 as an input. If the metalog distribution model is semi-bounded or bounded, the data transform inverse 770 of the data transformation 520 (previously used to create the 1D generative model 570 of FIG. 5 for each 1D data slice 620) is applied to the metalog samples 730 to generate the full synthetic dataset 780.

FIG. 8 illustrates a block diagram of an example application for the data fitting process 605 of FIG. 6. The example application takes specific advantage of the compact system representation inherent in an data fitting process 605 could be sensor data transmission of unmanned aerial vehicles (“UAVs”) for tactical situational awareness. A swarm of UAVs are deployed to scan an area for radio frequency (“RF”) emissions. Each UAV possesses several sensors 810 including, without limitation, a high data-rate RF energy detector, a high data-rate global positioning system (“GPS”) and inertial measurement unit (“IMU”), and several auxiliary system health sensors (temperature, pressure, air speed). UAV communication uplink connectivity is such that transmitting all this collected data in real time is unfeasible. However, mission control requires real time updates both of the UAV location, health, and RF levels. Instead of decimating the large data generated onboard the UAV, which may destroy crucial datapoints, the operators employ the data fitting process 605 onboard the UAV.

The onboard UAV processor batch processes its onboard data into a generative model 670, which is representative of all the high data-rate samples. (See, e.g., an “Adaptive Distributed Analytics System,” U.S. Pat. No. 12,013,680 introduced above). The UAV is able to transmit 820 the entire generative model 670 for each batch of data, as the number of model parameters is much smaller than the source dataset and thus requires lower communication bandwidth than would have otherwise been needed. In addition, the data fitting process 605 improves security by obfuscating the precise sensor data. The generative model 670 is received by the operators and can be used to generate a representative synthetic dataset 830 via the synthetic data generation (“SDG”) 700 to display a snapshot representation of what each UAV is experiencing, thus allowing full situational awareness by the operators. In addition, the synthetic dataset 830 can be employed by an onboard (or remote) processor and memory to monitor and control the UAV. Other use cases of this process such as AI federated learning, are comprehended.

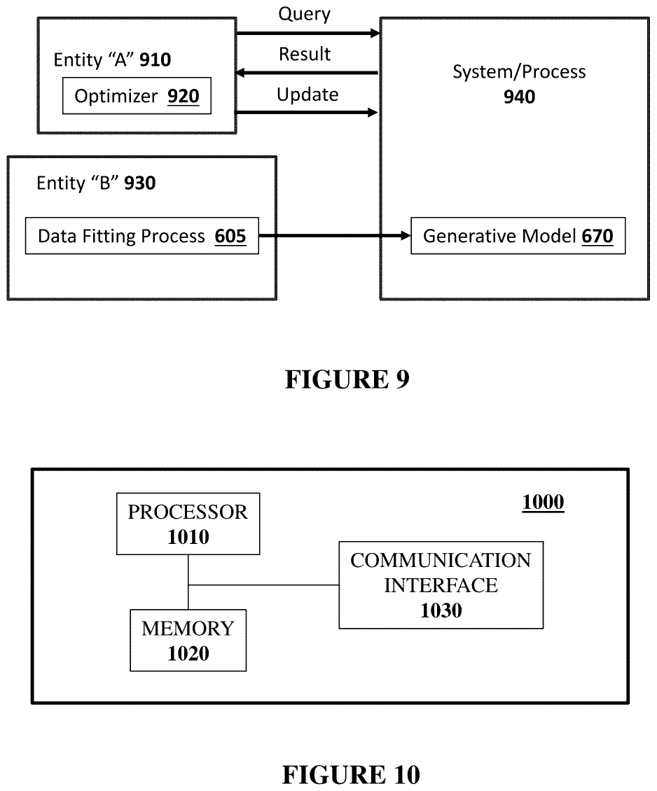

FIG. 9 illustrates a block diagram of an example application for the data fitting process 605 of FIG. 6. In addition to compression of raw sensor data, there are a multitude of optimization applications that could benefit from the automated creation and use of the data fitting process 605. Suppose an entity “A” 910 wishes to optimize a system/process 940. An optimizer 920 queries the system/process 940, which then produces a result to the optimizer 920 for assessment. The optimizer 920 then updates parameters of the system/process 940 and these steps are repeated until the system/process 940 is driven to a desired outcome. The TruSolve™ optimizer described in “System and Method for Adaptive Optimization (U.S. patent application Ser. No. 18/050,661 introduced above) could be one such optimizer 930.

Now suppose that this system/process 940 relies on data from entity “B” 930. Entity “B” 930 may have data privacy requirements such that it must anonymize the data before sharing to the system/process 940. By creating a generative model 670 using the data fitting process 605, entity “B” 930 can employ anonymization and simultaneously create a compact representation of its data which can be transmitted efficiently. It should be noted that the process can be owned in whole or in part by either entity “A” or “B” 910, 930 or another entity altogether. It is also comprehended that the process could contain generative data from multiple different entities.

Some optimization applications are described below, though others are comprehended. Consider a healthcare application wherein entity “A” 910 is a data analysis company and entity “B” 930 is a hospital. The analysis company has been contracted by the hospital to create a clustering process 940 to classify patient case outcome (including severity) and to prescribe treatment options. The hospital's patient data includes patient name, address, blood pressure systolic and diastolic readings, weight, birthday, etc. By means of the data fitting process 605, the hospital can quickly automate a data pipeline that creates a compact, representative, anonymized data source for a generative model 670. The data fitting process 605 is exercised to create a synthetic patient dataset that is used to train the clustering process 940 via the optimizer 920. The outcome of this is that the clustering process 940 can be optimized more quickly than if relying on manual data analysis, all whilst preserving patient privacy. In addition, the SDG system can generate treatment options for patients within clusters.

In supply chain, a different use case could be one in which there is a manufacturer (entity “A”) 910 that desires to create an optimal production and delivery schedule process 920 for their various retail customers (entity “B”) 930. To do this, they require historic store-level sales data for the final product. The retail customers 930 can share a generative model 670 created from their sensitive sales data and thus be assured that data privacy is respected. Because the product sales demand is assumed to be correlated with weather, the production and delivery schedule process 940 ingests historic data from global weather sensors deployed at many locations. The production and delivery schedule process 940 implicitly models consumer behavior and sales of the product at various locations for different retail customers 930. The optimizer (including a processor and memory) 920 can then exercise the production and delivery schedule process 940 to optimize a distribution strategy for the manufacturer, without requiring retail customers to share sensitive store-by-store sales data.

Consider a national security example where there are multiple emerging weapon systems that are known or expected, but of which very little operational data is available such as hypersonic missiles, directed energy weapons, and agile electronic warfare jammers. Counter measures to these systems are critical to national defense, however training, testing, and qualifying these counter measures requires an accurate threat model. The process 940 in this case is a threat model that is to be trained on a combination of weapons data and explicit modeling using this data. (See, e.g., “Generative Artificial Intelligence System and Method of Operating the Same,” U.S. patent application Ser. No. 18/773,333 introduced above.) However, very limited amounts of weapons data specific to these weapon systems has been collected by the intelligence community (entity “B”) 930, but this data can still be used to create a generative model 670. The generative model 670 can then be exercised to create sufficient synthetic operational data to effectively train the process 940 via the optimizer (including a processor and memory) 920. The outcome is a process 940 that did not require a prohibitive amount of collected data to produce an accurate result and ultimately prescribe countermeasures based thereon.

FIG. 10 illustrates a block diagram of an embodiment of an apparatus 1000 for operating systems and processes described herein such as the SDG system and optimizer. The apparatus 1000 includes a processor (or processing circuitry) 1010, a memory 1020 and a communication interface 1030 such as a graphical user interface. The apparatus 1000 operates the SDG system to create generative models and synthetic datasets to create outcomes to prescribe and/or perform actions such as to control, implement, design, monitor, operate and/or maintain (maintenance) of complex systems based on SDG generative models.

The functionality of the apparatus 1000 may be provided by the processor 1010 executing instructions stored on a computer-readable medium, such as the memory 1020 shown in FIG. 10. Alternative embodiments of the apparatus 1000 may include additional components (such as the interfaces, devices and circuits) beyond those shown in FIG. 10 that may be responsible for providing certain aspects of the device's functionality, including any of the functionality to support the solution described herein.

The processor 1010 (or processors), which may be implemented with one or a plurality of processing devices, perform functions associated with its operation including, without limitation, performing the operations of the systems and processed herein. The processor 1010 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The processor 1010 may include, without limitation, application processing circuitry. In some embodiments, the application processing circuitry may be on separate chipsets. In alternative embodiments, part or all of the application processing circuitry may be combined into one chipset, and other application circuitry may be on a separate chipset. In still alternative embodiments, part or all of the application processing circuitry may be on the same chipset, and other application processing circuitry may be on a separate chipset. In yet other alternative embodiments, part or all of the application processing circuitry may be combined in the same chipset.

The memory 1020 (or memories) may be one or more memories and of any type suitable to the local application environment, and may be implemented using any suitable volatile or nonvolatile data storage technology such as a semiconductor-based memory device, a magnetic memory device and system, an optical memory device and system, fixed memory and removable memory. The programs stored in the memory 1020 may include program instructions or computer program code that, when executed by an associated processor, enable the respective device 1000 to perform its intended tasks. Of course, the memory 1020 may form a data buffer for data transmitted to and from the same. Exemplary embodiments of the system, subsystems, and modules as described herein may be implemented, at least in part, by computer software executable by the processor 1010, or by hardware, or by combinations thereof.

The communication interface 1030 modulates information for transmission by the respective apparatus 1000 to another apparatus. The respective communication interface 1030 is also configured to receive information from another processor for further processing. The communication interface 1030 can support duplex operation for the respective other processor 1010.

The SDG system described herein can create the synthetic datasets using as few as three source datasets. The automation saves time by trying different metalog orders (different instances of the metalog distributions) under the hood, instead of putting the burden on the user to manually try different distributions. As a general description of traditional AI models (including GANs), they consist of billions and trillions of parameters (https://ourworldindata.org/grapher/artificial-intelligence-parameter-count), whilst common metalog distribution models typically are of order less than 20. However, the types of data being modeled by metalog distributions up to now are fairly low-dimensional. TABLE 1 below provides an example metalog data percentage reduction at various dimensions.

TABLE 1

| | | Dimension | | |
|---|---|---|---|---|
| | | 10 | 100 | 1000 |
| Metalog | 3 | 99.2% | 94.6% | 49.6% |
| Order | 10 | 98.4% | 94.0% | 49.0% |
| | 20 | 97.4% | 93.0% | 48.0% |

Returning to the analogy of distribution fits and compression, examine the reduction from raw datapoints to model coefficients. In general, for a source dataset with D dimensions, the covariance matrix contains D(D+1)/2 unique pairwise terms. Fitting D metalogs of order M generates DM coefficients. Thus, the total number of model parameters is D(D+1)/2+DM. For the Iris example, D=4 and M=3, 22 parameters are used for a single class, which means the effective “compression” with 40 initial 4D datapoints (160 values) is ~0.14. Stated another way, take the complement of the compression ratio and assume a data reduction of 86 percent (“%”), this data reduction percentage becomes larger (and better) with more data samples. TABLE 1 shows data reduction percentages for a range of M and D for a source dataset of n=1000 samples. The data reductions scale as (n-c)/n where c=(D+1)/2+M.

In one embodiment, a synthetic data generation system (200) operable on a processor (1010) and memory (1020), and related method, are disclosed herein. The synthetic data generation system (200) is configured to receive a source dataset (510), apply a data bound (525) to the source dataset (510) to create a bounded source dataset, transform (520) the bounded source dataset to create a transformed dataset, compute (530) an empirical cumulative distribution function (“eCDF”) of the transformed dataset to create eCDF probability values, and normalize (540) the eCDF probability values to create scaled eCDF values. The synthetic data generation system (200) is further configured to perform regression (550) on the scaled eCDF values to create metalog distribution models of differing order for the scaled eCDF values, and determine (560) one of the metalog distribution models of differing order that meets a measure of merit (565) to create a generative model (570). The synthetic data generation system (200) is further configured to receive random input data (710), calculate (740) an inverse cumulative distribution function (“CDF”) (750) based on the generative model (570), apply the random input data (710) to the inverse CDF (750) to create metalog samples (760) of the random input data (710), and apply an inverse transformation (770) to the metalog samples (760) to create a synthetic dataset (780) of the source dataset (510). Thus, the synthetic data generation system (200) produces a generative model (570) and a synthetic dataset (780) for a one dimensional source dataset (510).

In another embodiment, a synthetic data generation system (200) operable on a processor (1010) and memory (1020), and related method, are disclosed herein. The synthetic data generation system (200) is configured to create a generative model (670) including receive a source dataset (610), take a first one-dimensional data slice (620-1) of the source dataset (610), and perform a data fitting process (505) on the first one dimensional data slice (620-1) of the source dataset (610) The data fitting process (505) is configured to apply a data bound (525) to the first one dimensional data slice (620-1) to create a bounded first one dimensional data slice, transform (520) the bounded first one dimensional data slice to create a transformed dataset, compute (530) an empirical cumulative distribution function (“eCDF”) of the transformed dataset to create eCDF probability values, normalize (540) the eCDF probability values to create scaled eCDF values, perform regression (550) on the scaled eCDF values to create metalog distribution models of differing order for the scaled eCDF values, and determine (560) one of the metalog distribution models of differing order that meets a measure of merit (565) to create a first generative model (570-1).

The synthetic data generation system (200) is further configured to take a second one-dimensional data slice (620-D) of the source dataset (610), and perform the data fitting process (505) on the second one dimensional data slice (620-D) of the source dataset (610). The data fitting process (505) is configured to apply a data bound (525) to the second one dimensional data slice (620-D) to create a bounded second one dimensional data slice, transform (520) the bounded second one dimensional data slice to create a transformed dataset, compute (530) an empirical cumulative distribution function (“eCDF”) of the transformed dataset to create eCDF probability values, normalize (540) the eCDF probability values to create scaled eCDF values, perform regression (550) on the scaled eCDF values to create second metalog distribution models of differing order for the scaled eCDF values, and determine (560) one of the second metalog distribution models of differing order that meets a measure of merit (565) to create a second generative model (570-D). The synthetic data generation system (200) is further configured to compute correlations (630) between the first and second one-dimensional data slices (620-1, 620-D) to create correlation coefficients (640), apply the correlation coefficients (640) to the first and second generative models (570-1, 570-D) to create correlated first and second generative models, and add the correlated first and second generative models to create the generative model (670).

The synthetic data generation system (200) is further configured to generate a synthetic dataset (780) including receive random input data (710), create multivariate copula (720) from the correlation coefficients (640), apply the random input data (710) to the multivariate copula (720) to create copula samples (730) of the random input data (710), calculate (740) an inverse cumulative distribution function (“CDF”) (750) based on the generative model (670), apply the copula samples (730) to the inverse CDF (750) to create metalog samples (760) of the copula samples (730), and apply an inverse transformation (770) to the metalog samples (760) to create a synthetic dataset (780) of the source dataset (610). Thus, the synthetic data generation system (200) produces a generative model (670) and a synthetic dataset (780) for a multidimensional source dataset (610). While two dimensions were described in the example above, the synthetic data generation system (200) is applicable to multidimensional source datasets (610) of D dimensions, where D can include any number of dimensions.

As described above, the exemplary embodiments provide both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1. A synthetic data generation system operable on a processor and memory, configured to:
receive a source dataset;
apply a data bound to said source dataset to create a bounded source dataset;
transform said bounded source dataset to create a transformed dataset;
compute an empirical cumulative distribution function (eCDF) of said transformed dataset to create eCDF probability values;
normalize said eCDF probability values to create scaled eCDF values;
perform regression on said scaled eCDF values to create metalog distribution models of differing order for said scaled eCDF values;
determine one of said metalog distribution models of differing order that meets a measure of merit to create a generative model;
receive random input data;
calculate an inverse cumulative distribution function (CDF) based on said generative model;
apply said random input data to said inverse CDF to create metalog samples of said random input data; and
apply an inverse transformation to said metalog samples to create a synthetic dataset of said source dataset.

2. The synthetic data generation system as recited in claim 1 wherein said processor and memory are configured to determine said one of said metalog distribution models of differing order that meets said measure of merit to create said generative model using an iterative process.

3. The synthetic data generation system as recited in claim 1 wherein said measure of merit comprises a goodness-of-fit test.

4. The synthetic data generation system (200) as recited in claim 1 wherein said generative model (570) is a significantly compressed version of said source dataset (510).

5. The synthetic data generation system as recited in claim 1 wherein said generative model and said synthetic dataset are employed to monitor and control complex systems.

6. A method of operating a synthetic data generation system on a processor and memory, comprising:
receiving a source dataset;
applying a data bound to said source dataset to create a bounded source dataset;
transforming said bounded source dataset to create a transformed dataset;
computing an empirical cumulative distribution function (eCDF) of said transformed dataset to create eCDF probability values;
normalizing said eCDF probability values to create scaled eCDF values;
performing regression on said scaled eCDF values to create metalog distribution models of differing order for said scaled eCDF values;
determining one of said metalog distribution models of differing order that meets a measure of merit to create a generative model;
receiving random input data;
calculating an inverse cumulative distribution function (CDF) based on said generative model;
applying said random input data to said inverse CDF to create metalog samples of said random input data; and
applying an inverse transformation to said metalog samples to create a synthetic dataset of said source dataset.

7. The method as recited in claim 6 wherein said determining said one of said metalog distribution models of differing order that meets said measure of merit to create said generative model is an iterative process.

8. The method as recited in claim 6 wherein said measure of merit comprises a goodness-of-fit test.

9. The method as recited in claim 6 wherein said generative model is a significantly compressed version of said source dataset.

10. The method as recited in claim 6 wherein said generative model and said synthetic dataset are employed to monitor and control complex systems.

11. A synthetic data generation system operable on a processor and memory, configured to:
create a generative model, comprising:
receive a source dataset,
take a first one-dimensional data slice of said source dataset;
perform a data fitting process on said first one dimensional data slice of said source dataset, comprising:
apply a data bound to said first one dimensional data slice to create a bounded first one dimensional data slice,
transform said bounded first one dimensional data slice to create a transformed dataset,
compute an empirical cumulative distribution function (eCDF) of said transformed dataset to create eCDF probability values,
normalize said eCDF probability values to create scaled eCDF values,
perform regression on said scaled eCDF values to create metalog distribution models of differing order for said scaled eCDF values, and
determine one of said metalog distribution models of differing order that meets a measure of merit to create a first generative model,
take a second one-dimensional data slice of said source dataset,
perform said data fitting process on said second one dimensional data slice of said source dataset, comprising:
apply a data bound to said second one dimensional data slice to create a bounded second one dimensional data slice,
transform said bounded second one dimensional data slice to create a transformed dataset,
compute an empirical cumulative distribution function (eCDF) of said transformed dataset to create eCDF probability values,
normalize said eCDF probability values to create scaled eCDF values,
perform regression on said scaled eCDF values to create second metalog distribution models of differing order for said scaled eCDF values,
determine one of said second metalog distribution models of differing order that meets a measure of merit to create a second generative model,
compute correlations between said first and second one-dimensional data slices to create correlation coefficients,
apply said correlation coefficients to said first and second generative models to create correlated first and second generative models, and
add said correlated first and second generative models to create said generative model; and
generate a synthetic dataset, comprising:
receive random input data,
create multivariate copula from said correlation coefficients,
apply said random input data to said multivariate copula to create copula samples of said random input data,
calculate an inverse cumulative distribution function (CDF) based on said generative model,
apply said copula samples to said inverse CDF to create metalog samples of said copula samples, and
apply an inverse transformation to said metalog samples to create a synthetic dataset of said source dataset.

12. The synthetic data generation system as recited in claim 11 wherein said processor and memory are configured to determine said one of said metalog distribution models of differing order that meets said measure of merit to create said first and second generative models using an iterative process.

13. The synthetic data generation system as recited in claim 11 wherein said measure of merit comprises a goodness-of-fit test.

14. The synthetic data generation system as recited in claim 11 wherein said generative model is a significantly compressed version of said source dataset.

15. The synthetic data generation system as recited in claim 11 wherein said generative model and said synthetic dataset are employed to monitor and control complex systems.

16. A method of operating a synthetic data generation system on a processor and memory, comprising:
creating a generative model, comprising:
receiving a source dataset,
taking a first one-dimensional data slice of said source dataset;
performing a data fitting process on said first one dimensional data slice of said source dataset, comprising:
applying a data bound to said first one dimensional data slice to create a bounded first one dimensional data slice,
transforming said bounded first one dimensional data slice to create a transformed dataset,
computing an empirical cumulative distribution function (eCDF) of said transformed dataset to create eCDF probability values,
normalizing said eCDF probability values to create scaled eCDF values,
performing regression on said scaled eCDF values to create metalog distribution models of differing order for said scaled eCDF values, and
determining one of said metalog distribution models of differing order that meets a measure of merit to create a first generative model,
taking a second one-dimensional data slice of said source dataset,
performing said data fitting process on said second one dimensional data slice of said source dataset, comprising:
applying a data bound to said second one dimensional data slice to create a bounded second one dimensional data slice,
transforming said bounded second one dimensional data slice to create a transformed dataset,
computing an empirical cumulative distribution function (eCDF) of said transformed dataset to create eCDF probability values,
normalizing said eCDF probability values to create scaled eCDF values,
performing regression on said scaled eCDF values to create second metalog distribution models of differing order for said scaled eCDF values,
determining one of said second metalog distribution models of differing order that meets a measure of merit to create a second generative model,
computing correlations between said first and second one-dimensional data slices to create correlation coefficients,
applying said correlation coefficients to said first and second generative models to create correlated first and second generative models, and
adding said correlated first and second generative models to create said generative model; and
generating a synthetic dataset:
receiving random input data,
creating multivariate copula from said correlation coefficients,
applying said random input data to said multivariate copula to create copula samples of said random input data,
calculating an inverse cumulative distribution function (CDF) based on said generative model,
applying said copula samples to said inverse CDF to create metalog samples of said copula samples, and
applying an inverse transformation to said metalog samples to create a synthetic dataset of said source dataset.

17. The method as recited in claim 16 wherein said determining said one of said metalog distribution models of differing order that meets said measure of merit to create said first and second generative models is an iterative process.

18. The method as recited in claim 16 wherein said measure of merit comprises a goodness-of-fit test.

19. The method as recited in claim 16 wherein said generative model is a significantly compressed version of said source dataset.

20. The method as recited in claim 16 wherein said generative model and said synthetic dataset are employed to monitor and control complex systems.
